(19) United States
(12) Patent Application Publication
(10) Pub. No.: US 2012/0081523 A1
(43) Pub. Date: Apr. 5, 2012

(54) 2D/3D COMPATIBLE DISPLAY SYSTEM WHICH AUTOMATICALLY SWITCHES OPERATIONAL MODES

(76) Inventors: Shu-Ming Liu, Tainan County (TW); Hsuan-Ching Liu, Tainan County (TW)

(21) Appl. No.: 12/896,918

(22) Filed: Oct. 4, 2010

(51) Int. Cl. H04N 13/04

(52) U.S. Cl. 348/51; 348/E13.075

(57) ABSTRACT

A 2D/3D compatible display system includes an image source and a 3D viewing device. When a viewer is wearing the 3D viewing device 230, the 3D viewing device 230 automatically instructs the image source 210 to operate in 3D mode. When the 3D viewing device 230 is not in use, the 3D viewing device 230 automatically instructs the image source 210 to operate in 2D mode.

### BACKGROUND OF THE INVENTION

1. Field of the Invention

The present invention is related to a 2D/3D compatible display system, and more particularly, to a 2D/3D compatible display system which automatically switches operational modes.

2. Description of the Prior Art

Three-dimensional (3D) display technology provides more vivid visual experiences than traditional two-dimensional (2D) display technology. In general, the stereoscopic image processing involves two camera systems in which two different images or videos are taken from slightly different camera angles and locations. The object is to simulate the manner in which depth is perceived by a pair of human eyes, which are themselves slightly offset from each other and thus view images at slightly different angles. The two camera images or videos are superimposed as an integrated stereoscopic image and presented to the viewer simultaneously on a television or movie screen. The two camera images are then separated in some fashion for the viewer so that one eye sees only one image and the other eye sees only the other image. In this way, an illusion of depth is created by simulating normal vision. The visual cortex of the human brain fuses this into perception of a 3D scene or composition.

There are two major types of 3D viewing environments: naked-eye and glasses-type. In naked-eye 3D viewing environment, stereoscopic images are directly generated using e-holographic, volumetric, multi-planar or multiplexed 2D display devices and can be viewed without additional devices. In glasses-type viewing environment, 3D viewing devices, such as polarizing glasses, anaglyph glasses, or shutter glasses, are required to creating the illusion of stereoscopic images from planer images.

Most glasses-type 3D display system also support regular 2D mode. FIG. 1 is a functional block diagram illustrating a prior art 2D/3D compatible display system 100. The 2D/3D compatible display system 100 includes an image source 110, a remote controller 120, and a 3D viewing device 130. Normally, the 2D/3D compatible display system 100 operates in 2D mode. If a viewer wants to watch a 3D movie, he needs to put on the 3D viewing glasses 130 and manually switch the 2D/3D compatible display system 100 to 3D mode using the remote controller 120. If the viewer wants to watch regular 2D programs after finishing the 3D movie, he needs to switch the 2D/3D compatible display system 100 back to 2D mode using the remote controller 120. In other words, the remote controller 120 is required to switch the operational modes of the prior art 2D/3D compatible display system 100 and this kind of manual switch may cause inconvenience to the viewer.

### SUMMARY OF THE INVENTION

The present invention provides a 2D/3D compatible display system which includes an image source configured to operate in a 2D mode or a 3D mode according to a control signal; and a 3D viewing device for creating a stereoscopic effect when used in viewing images provided by the image source which operates in the 3D mode, and configured to generate the control signal when placed in a specific viewing position on a viewer so as to operate the 3D viewing device in the 3D mode.

The present invention also provides a 3D viewing device for creating a stereoscopic effect when used in a 2D/3D compatible display system and configured to instruct the 2D/3D compatible display system to operate in a 3D mode when placed in a specific viewing position on a viewer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a prior art 2D/3D compatible display system.

FIG. 2 is a functional block diagram illustrating a 2D/3D compatible display system according to the present invention.

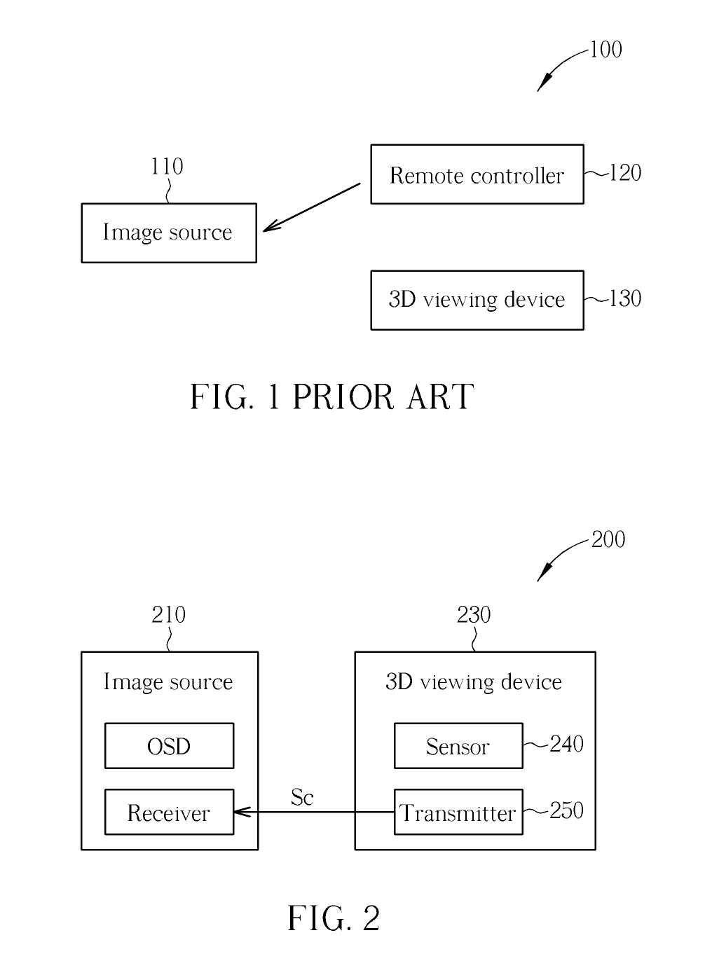

### DETAILED DESCRIPTION

FIG. 2 is a functional block diagram illustrating a 2D/3D compatible display system 200 according to the present invention. The 2D/3D compatible display system 200 includes an image source 210 and a 3D viewing device 230. The image source 210 is configured to provide regular 2D images when operating in a 2D mode and provide 2D images for 3D processing when operating in a 3D mode. The image source 210 may include a 3D-ready TV set, a computer, a projector, or other equipment having similar function. The image source 210 is configured to switch operational modes according to a control signal Sc received from the 3D viewing device 230 by its receiver.

In one embodiment of the present invention, the 2D/3D compatible display system 200 may operate in 3D mode based on polarized stereoscopy and the 3D viewing device 230 is polarizing glasses. In 3D mode, two images associated with the same object are projected superimposed onto the same screen through orthogonal polarizing filters (e.g. one with vertical polarization and one with horizontal polarization) . The viewer wears polarizing glasses which also contain a pair of orthogonal polarizing filters oriented in the same manner as the projector (e.g. one eye horizontal and one eye vertical). As each filter only passes light which is similarly polarized and blocks the orthogonally polarized light, each eye only sees one of the projected images, thereby creating the illusion of stereoscopic images.

In another embodiment of the present invention, the 2D/3D compatible display system 200 may operate in 3D mode based on anaglyphic stereoscopy and the 3D viewing device 230 is anaglyphic glasses. In 3D mode, two images associated with the same object are color coded, for example with red and green respectively. The viewer wears two-color anaglyph glasses having different colored filters (chromatically opposite color, usually red and cyan) in front of each eye. Each filter rejects the image that is not intended for that eye, and transmits the image which is intended to be seen by that eye. Images may then be perceived as two color layers, superimposed, but offset with respect to each other to produce a depth effect, thereby creating the illusion of stereoscopic images.

In another embodiment of the present invention, the 2D/3D compatible display system 200 may operate in 3D mode based on alternative frame sequencing stereoscopy and the 3D viewing device 230 is liquid crystal shutter glasses. In 3D mode, the sequential presentation of left- and right-eye images is provided. The viewer wears liquid crystal shutter glasses which alternatively darken over one eye, and then the other, in synchronization with the refresh rate of the screen. Using alternative frame sequencing technique, the left- and right-eye images are respectively presented when the corresponding glasses are turned on, thereby creating the illusion of stereoscopic images.

According to different 3D image processing techniques, the 3D viewing device 230 may be polarizing glasses, anaglyph glasses, shutter glasses or other types of glasses capable of creating a stereoscopic effect when used in viewing the 2D images provided by the image source 210 which operates in 3D mode. In the present invention, the 3D viewing device 230 is able to detect whether it is currently being used by a viewer and automatically switch the operational mode of the image source 210. Therefore, there is no need to use a remote controller to switch between 2D/3D modes.

In an embodiment of the present invention, the 3D viewing device 230 may include a sensor 240 and a transmitter 250. The sensor 240 is configured to detect whether the 3D viewing device 230 is placed in a specific viewing position (such as on the bridge of the nose and over the ears of the viewer). The sensor 240 may be disposed on the 3D viewing device 230 at various locations as long as a parameter change before and after the 3D viewing device 230 is placed in the specific viewing position can be detected. For example, the sensor 240 may be disposed on the nose pads, temple arms or ear stems of polarizing/anaglyph/shutter glasses which, when in use, are in contact of human face. Therefore, the sensor 240 may be configured to detect the variation in pressure or capacitance as a result of contacting human face, thereby determining whether the viewer is currently wearing the 3D viewing device 230.

Normally, the 2D/3D compatible display system 200 operates in 2D mode and the user only puts on the 3D viewing device 230 when he intends to watch a 3D video. In one embodiment, the control signal Sc is generated only when the sensor 240 detects that the user is currently wearing the 3D viewing device 230. The image source 210 automatically switches to 3D mode upon receiving the control signal Sc from the transmitter 250 and continues to operate in 3D mode with the presence of the control signal Sc. After the viewer finishes watching the 3D video and takes off the 3D viewing device 230, the transmitter 250 stops sending the control signal Sc and the image source 210 automatically switches to 2D mode and continues to operate in 2D mode when the control signal Sc is absent.

In another embodiment, the control signal Sc is always generated but differs according to whether the user is currently wearing the 3D viewing device 230. Therefore, the image source 210 may automatically operate in 3D mode when receiving the control signal Sc which indicates that the 3D viewing device 230 is currently in use, or may automatically operate in 2D mode when receiving the control signal Sc which indicates that the 3D viewing device 230 is not in use.

In the present invention, the image source 210 may automatically switch to 3D mode once the viewer puts on the 3D viewing device 230 and automatically switch to 2D mode once the viewer takes off the 3D viewing device 230. The image source 210 may also present an on-screen display (OSD) on its screen so as to inform the viewer about the current operational mode. The switching between 2D/3D modes is controlled by the 3D viewing device 230 and no additional remote controller is required. The present invention can thus provide a more convenient 2D/3D viewing environment.

Those skilled in the art will readily observe that numerous modifications and alterations of the device and method may be made while retaining the teachings of the invention.

What is claimed is:

1. A two-dimensional/three-dimensional (2D/3D) compatible display system, comprising:
an image source configured to operate in a 2D mode or a 3D mode according to a control signal; and
a 3D viewing device for creating a stereoscopic effect when used in viewing images provided by the image source which operates in the 3D mode, and configured to generate the control signal when placed in a specific viewing position on a viewer so as to operate the 3D viewing device in the 3D mode.

2. The 2D/3D compatible display system of claim 1, wherein the 3D viewing device comprises:
a transmitter configured to send the control signal to the image source; and
a sensor configured to detect whether the 3D viewing device is placed in the specific viewing position and generate the control signal accordingly so as to instruct the image source to operate in the 3D mode when the 3D viewing device is placed in the specific viewing position.

3. The 2D/3D compatible display system of claim 2, wherein the sensor is further configured to generate the control signal so as to instruct the image source to operate in the 2D mode when the 3D viewing device is not placed in the specific viewing position.

4. The 2D/3D compatible display system of claim 2, wherein the sensor is configured to detect a variation in pressure or capacitance which is induced after the 3D viewing device is placed in the specific viewing position.

5. The 2D/3D compatible display system of claim 2, wherein the sensor is disposed on the 3D viewing device at a location which is in contact of the viewer when the 3D viewing device is placed in the specific viewing position.

6. The 2D/3D compatible display system of claim 1, wherein the image source is configured to operate in the 3D mode when receiving the control signal and operate in the 2D mode when the control signal is not detected.

7. The 2D/3D compatible display system of claim 1, wherein the image source is configured to present anon-screen display (OSD) on a screen so as to inform the user about a current operational mode of the image source.

8. A 3D viewing device for creating a stereoscopic effect when used in a 2D/3D compatible display system and configured to instruct the 2D/3D compatible display system to operate in a 3D mode when placed in a specific viewing position on a viewer.

9. The 3D viewing device of claim 8 comprising:
a transmitter configured to send a control signal to the image source; and
a sensor configured to detect whether the 3D viewing device is placed in the specific viewing position and generate the control signal accordingly so as to instruct the 2D/3D compatible display system to operate in the 3D mode when the 3D viewing device is placed in the specific viewing position.

10. The 3D viewing device of claim 9, wherein the sensor is configured to generate the control signal so as to instruct the 2D/3D compatible display system to operate in the 2D mode when the 3D viewing device is not placed in the specific viewing position.

11. The 3D viewing device of claim 8, wherein the sensor is configured to detect a variation in pressure or capacitance which is induced after the 3D viewing device is placed in the specific viewing position.

12. The 3D viewing device of claim 8, wherein the sensor is disposed on the 3D viewing device at a location which is in contact of the viewer when the 3D viewing device is placed in the specific viewing position.
